(19) United States
(12) Patent Application Publication
(10) Pub. No.: US 2021/0406681 A1
(43) Pub. Date: Dec. 30, 2021

(54) LEARNING LOSS FUNCTIONS USING DEEP LEARNING NETWORKS

(71) Applicant: GE Precision Healthcare LLC, Milwaukee, WI (US)

(72) Inventors: Dattesh Shanbhag, Bengaluru (IN); Hariharan Ravishankar, Bengaluru (IN); Utkarsh Agrawal, Bengaluru (IN)

(21) Appl. No.: 16/987,449

(22) Filed: Aug. 7, 2020

(30) Foreign Application Priority Data
Jun. 26, 2020 (IN) 202041027098

(51) Int. Cl. G06N 3/08; G06N 3/04

(52) U.S. Cl. CPC G06N 3/08; G06N 3/0454

(57) ABSTRACT

Techniques are provided for learning loss functions using DL networks and integrating these loss functions into DL based image transformation architectures. In one embodiment, a method is provided that comprising facilitating training, by a system operatively coupled to a processor, a first deep learning network to predict a loss function metric value of a loss function. The method further comprises employing, by the system, the first deep learning network to predict the loss function metric value in association with training a second deep learning network that to perform a defined deep learning task. In various embodiments, the loss function comprises a computationally complex loss function that is not easily implementable in existing deep learning packages, such as a non-differentiable loss function, a feature similarity index match (FSIM) loss function, a system transfer function, a visual information fidelity (VIF) loss function and the like.

### RELATED APPLICATION

This application claims priority to India Provisional Patent Application No. 202041027098 filed Jun. 26, 2020 and titled “LEARNING LOSS FUNCTIONS USING DEEP LEARNING NETWORKS,” the entirety of which application is incorporated herein by reference.

### TECHNICAL FIELD

This application generally relates to deep learning and more particularly to computer-implemented techniques for learning loss functions using deep learning (DL) networks.

### BACKGROUND

Deep learning (DL) based image reconstruction has gained traction in recent years due to its ability to mimic the entire image reconstruction chain and accelerate scanning with reduced data. The quality of images reconstructed using DL networks is dictated by the network architecture, and more importantly, by the loss function(s) used to drive the optimization. This is especially crucial in medical image reconstruction.

Currently, most of the DL based image reconstruction networks are based on standard a mean-squared error (MSE) based loss function, a mean-absolute-error (MAE) based loss function, or a structural similarity (SSIM) based loss function. However, these loss functions do not always accurately interpret image quality. Consequently, images predicted by DL network relying on these loss functions often suffer from image artifacts such as blurring, distortion or hallucinations.

In practice, radiologist perception of the image is the final adjudicating factor in determining the performance of DL based image reconstruction. Recent work suggests that most of the loss functions mentioned above don't correlate well with radiologist perception of image quality. Some perception studies for image compression protocols have found the feature similarity index metric (FSIM) and the visual information fidelity (VIF) metric better mimic radiologist perception of image quality. However, although these metrics offer improved accuracy in terms of image quality, the mathematical formulations of these indexes are significantly more complex than traditional loss functions such as MSE, MAE and SSIM. In addition, the constructs required for implementing these loss functions are not readily available in standard DL toolkits such as TensorFlow and are hard to implement using basic tensor constructs. Consequently, these loss functions have not been successfully integrated into DL network architectures.

### SUMMARY

The following presents a summary to provide a basic understanding of one or more embodiments of the invention. This summary is not intended to identify key or critical elements or to delineate any scope of the particular embodiments or any scope of the claims. Its sole purpose is to present concepts in a simplified form as a prelude to the more detailed description that is presented later. In one or more embodiments described herein, systems, computer-implemented methods, apparatus and/or computer program products that facilitate learning loss functions using DL networks and integrating these loss functions into DL based image transformation architectures.

According to an embodiment, a method is provided that comprising facilitating training, by a system operatively coupled to a processor, a first deep learning network to predict a loss function metric value of a loss function. The method further comprises employing, by the system, the first deep learning network to predict the loss function metric value in association with training a second deep learning network to perform a defined deep learning task. In various embodiments, the loss function comprises a computationally complex loss function that is not easily implementable in existing deep learning packages, such as a non-differentiable loss function, a feature similarity index match (FSIM) loss function, a system transfer function, a visual information fidelity (VIF) loss function and the like. In one or more embodiments, the defined deep learning task comprises an image reconstruction task. For example, in some implementations, the second deep learning network can comprise a medical image reconstruction DL network.

In some embodiments, elements described in connection with the disclosed computer-implemented methods can be embodied in different forms such as a computer system, a computer program product, or another form.

### DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a block diagram of an example, non-limiting system that facilitates learning loss functions using DL networks and integrating these loss functions into DL based image transformation architectures, in accordance with one or more embodiments of the disclosed subject matter.

FIG. 2 presents example DL model predicted and ground truth phase congruency maps for a knee magnetic resonance imaging (MRI) scan in accordance with one or more embodiments of the disclosed subject matter.

FIG. 3 presents example DL model predicted and ground truth phase congruency maps for a knee positron emission tomography (PET) scan in accordance with one or more embodiments of the disclosed subject matter.

FIG. 4 illustrates an example architecture for training a loss function DL model in accordance with one or more embodiments of the disclosed subject matter.

FIG. 5 presents example computed tomography image data associated with an DL based image reconstruction task in accordance with one or more embodiments of the disclosed subject matter.

FIG. 6 presents image data comparing different DL based image reconstructions generated using different loss functions in accordance with one or more embodiments of the disclosed subject matter.

FIG. 7 presents a graph comparing the reconstruction accuracy of different DL based image reconstruction networks with different loss functions in accordance with one or more embodiments of the disclosed subject matter.

FIG. 8 presents another graph comparing the reconstruction accuracy of different DL based image reconstruction networks with different loss functions in accordance with one or more embodiments of the disclosed subject matter.

FIG. 9 illustrates a flow diagram of an example, non-limiting process for learning a loss functions using a first DL network and employing the loss functions to train a second DL network in accordance with one or more embodiments of the disclosed subject matter.

FIG. 10 illustrates a flow diagram of another example, non-limiting process for learning a loss functions using a first DL network and employing the loss functions to train a second DL network in accordance with one or more embodiments of the disclosed subject matter.

FIG. 11 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

The subject disclosure provides systems, computer-implemented methods, apparatus and/or computer program products that facilitate learning loss functions using DL networks and integrating these loss functions into DL based image transformation architectures. Various image metrics, such as FSIM and VIF have been found to provide an accurate assessment of image quality. For example, as applied to medical images, these metrics are considered to match more closely with radiologists' assessment of image quality relative to traditional image metrics employed in DL based image loss functions, including MSE, MAE, and SSIM. However, these metrics are non-differentiable and computational sub-components required to compute these metrics are not easily implementable DL packages, making their usage in DL image reconstruction networks challenging.

The disclosed subject matter provides techniques for efficiently and effectively integrating complex loss functions based on FSIM, VIF and the like into DL networks for image reconstruction and other tasks. The disclosed techniques involve training a separate DL network to learn a complex loss function from its analytical counter-parts through supervised training. For example, in one or more implementations, a separate DL network can be trained to predict a loss function metric, such FSIM, VIF or the like. Once trained, the loss function DL network can be used as a “pluggable” loss function module to subsequently drive other neural networks to model properties of interest.

While various embodiments of the disclosed techniques focuses on imaging metrics, these techniques can be suitably adapted for metrics in other domains such as signals or system transfer functions; which hitherto could not be used due to lack of implementation details (but final output available) or non-differentiable criteria in training DL networks. In this regard, the disclosed techniques can be used to generate pluggable loss functions for various domain specific problems solved with DL networks.

The term “image processing model” is used herein to refer to an AI/ML model configured to perform an image processing or analysis task on images. The image processing or analysis task can vary. In various embodiments, the image processing or analysis task can include, (but is not limited to): a segmentation task, an image reconstruction task, an object recognition task, a motion detection task, a video tracking task, an optical flow task, and the like. The image processing models described herein can include two-dimensional image processing models (2D) as well as three-dimensional (3D) image processing models. The image processing model can employ various types of AI/ML algorithms, including (but not limited to): deep learning models, neural network models, deep neural network models (DNNs), convolutional neural network models (CNNs), and the like.

The term “image-based inference output” is used herein to refer to the determination or prediction that an image processing model is configured to generate. For example, the image-based inference output can include a segmentation mask, a reconstructed image, an adapted image, an annotated image, a classification, a value, or the like. The image-based inference output can vary based on the type of the model and the particular task that the model is configured to perform. The image-based inference output can include a data object that can be rendered (e.g., a visual data object), stored, used as input for another processing task, or the like. The terms “image-based inference output”, “inference output” “inference result” “inference”, “output”, “predication”, and the like, are used herein interchangeably unless context warrants particular distinction amongst the terms.

As used herein, a “medical imaging processing model” refers to an image processing model that is tailored to perform an image processing/analysis task on one or more medical images. For example, the medical imaging processing/analysis task can include (but is not limited to): organ segmentation, anomaly detection, anatomical feature characterization, medical image reconstruction, diagnosis, and the like. The types of medical images processed/analyzed by the medical image processing model can include images captured using various types of imaging modalities. For example, the medical images can include (but are not limited to): radiation therapy (RT) images, X-ray images, digital radiography (DX) X-ray images, X-ray angiography (XA) images, panoramic X-ray (PX) images, computerized tomography (CT) images, mammography (MG) images (including a tomosynthesis device), a magnetic resonance imaging (MRI) images, ultrasound (US) images, color flow doppler (CD) images, position emission tomography (PET) images, single-photon emissions computed tomography (SPECT) images, nuclear medicine (NM) images, and the like. The medical images can include two-dimensional (2D) images as well as three-dimensional images (3D).

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

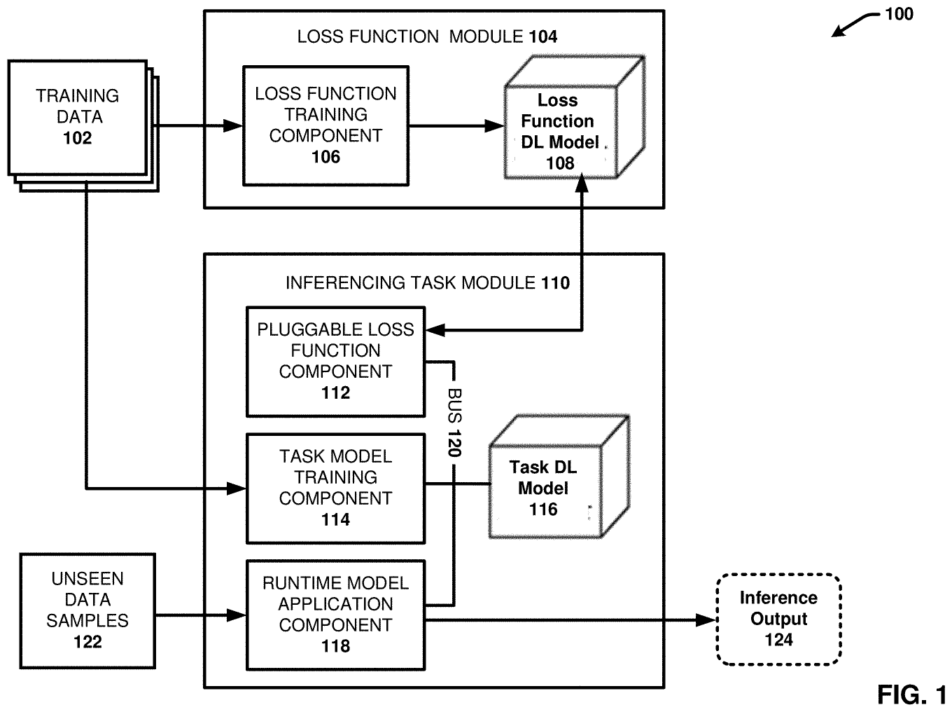

Turning now to the drawings, FIG. 1 illustrates a block diagram of an example, non-limiting system 100 that facilitates learning loss functions using DL networks and integrating these loss functions into DL based image transformation architectures, in accordance with one or more embodiments of the disclosed subject matter. Embodiments of systems described herein can include one or more machine-executable components embodied within one or more machines (e.g., embodied in one or more computer-readable storage media associated with one or more machines). Such components, when executed by the one or more machines (e.g., processors, computers, computing devices, virtual machines, etc.) can cause the one or more machines to perform the operations described.

For example, system 100 includes a loss function module 104 and an inferencing task module 110 which can respectively be and include machine-executable components. In the embodiment shown, the loss function module 104 includes a loss function training component 106 and a loss function DL model 108, which can respectively be and include machine-executable components. The inferencing task module 110 includes a pluggable loss function component 112, a task model training component 114, a task DL model 116, and a runtime model application component 118, which can respectively be and include machine-executable components. The inferencing task module 110 further includes a system bus 120 that operatively couples the components therein.

These machine-executable components of system 100 can be stored in memory (not shown) associated with the one or more machines (not shown). The memory can further be operatively coupled to at least one processor (not shown), such that the components (e.g., the loss function module 104, the inferencing task module 110 and the components respectively associated therewith), can be executed by the at least one processor to perform the operations described. Examples of said and memory and processor as well as other suitable computer or computing-based elements, can be found with reference to FIG. 13, and can be used in connection with implementing one or more of the systems or components shown and described in connection with FIG. 1 or other figures disclosed herein.

It should be appreciated that the embodiments of the subject disclosure depicted in various figures disclosed herein are for illustration only, and as such, the architecture of such embodiments are not limited to the systems, devices, and/or components depicted therein. In some embodiments, one or more of the components of system 100 can be executed by different computing devices (e.g., including virtual machines) separately or in parallel in accordance with a distributed computing system architecture. System 100 can also comprise various additional computer and/or computing-based elements described herein with reference to operating environment 1300 and FIG. 13. In several embodiments, such computer and/or computing-based elements can be used in connection with implementing one or more of the systems, devices, components, and/or computer-implemented operations shown and described in connection with FIG. 1 or other figures disclosed herein.

The loss function training component 106 can facilitate training and developing one or more loss function DL models 108 to predict a loss function metric of a loss function. The loss function metric can comprise a metric of essentially any loss function. In various embodiments, the loss function metric can include a metric that is computationally complex and/or otherwise difficult to implement by DL networks using standard DL toolkits or constructs such as TensorFlow and similar toolkits. For example, many standard DL toolkits cannot implement non-differentiable loss functions. Thus, in one or more embodiments, the loss function DL model 108 can comprise a model trained to predict or otherwise generate a non-differentiable loss function metric or value, including but not limited to, a FSIM index or an associated metric, or a VIF index or associated metric.

In other embodiments, the loss function metric can comprise one or more metrics of loss functions that are difficult to construct. For example, the loss function could be hard to construct due to missing details yet still have the analytic output available. In another example, the loss function could be difficult to implement in standard DL networks due to usage of constructs not available in deep learning packages or toolkits. In another embodiment, the loss function metric can comprise a metric of a system transfer function, such as a multivariable system transfer function.

The type of DL architecture employed for the loss function DL model 108 can vary. In some embodiments, the loss function DL model 108 can employ a convolutional neural network (CNN) architecture. Other suitable DL architectures for the loss function DL model 108 can include but are not limited to, recurrent neural networks, recursive neural networks, and classical neural networks. Depending on the type of DL architecture employed, the loss function DL model 108 can be trained using supervised machine learning techniques, semi-supervised machine learning techniques, and in some implementations, unsupervised machine learning techniques.

Once trained and developed, the loss function DL model 108 can be applied by the inferencing task module 110 to predict the loss function metric to train another DL model to perform a particular inferencing task. In the embodiment shown, this other DL model is referred to as task DL model 116. The inferencing task performed by the task DL model 116 can vary.

In one or more embodiments, the task DL model 116 can be an image processing model. In accordance with theses embodiments, the loss function DL model 108 can be trained to predict a loss function metric that is generalized for a wide-range of image processing tasks (e.g. synthesizing image textures for natural images). Additionally, or alternatively, the loss function DL model 108 can be trained to predict a loss function metric that is customized to a particular inferencing task (e.g., medical image reconstruction). It should be appreciated that the specificity of the loss function DL model 108 can be tailored based on the training data 102 used to train and develop the loss function DL model.

In this regard, in some embodiments, the task DL model 116 can be trained (e.g., by the task model training component 114) using the same or similar training data 102 used to train the loss function DL model 108. In other embodiments, the training data used to train the loss function DL model 108 and the task DL model 116 can be dissimilar. For example, as applied to imaging analysis, the training data 102 used to train the loss function DL model 108 can comprise a variety of images from a variety of different domains, while the training data used to train the task DL model 116 can be more specific to a particular image data set and inferencing task. For instance, in various embodiments, the loss function DL model 108 can be trained to predict a loss function imaging metric for assessment of medical images as applied to medical image processing and analysis tasks (e.g., reconstruction tasks, segmentation tasks, diagnosis tasks, anomaly detection, etc.) and the task DL model can be a medical image processing model. With these embodiments, the loss function DL model 108 can be trained on the same type of medical images used to train the task DL model 116 and/or a variety of different types medical images from a variety of different domains.

In the embodiment shown, the inferencing task module 110 can include a pluggable loss function component, a task model training component 114, a task DL model 116 and a runtime model application component 118. The pluggable loss function component 112 can be configured to apply the (trained) loss function DL model 108 to predict or otherwise generate the loss function metric in association with training the task DL model 116. In particular, the loss function DL model 108 can be used to train various types of task DL models 116 to better differentiate between task DL model 116 generated inference outputs and their corresponding ground truth examples by using the loss function DL model 108 generated metric, providing finely tuned loss evaluation. In this regard, the pluggable loss function component 112 essentially provides “pluggable loss function” application for plugging in the loss function metric value of the loss function DL model 108 into the task DL model 116. In some embodiments, the task model training component 114 can employ the loss function DL model 108 metric in combination with one or more other loss function metrics to facilitate training the task DL model 116. For example, the one or more other loss function metrics can include (but are not limited to), MAE, SSIM, MSE, SSIM and the like.

Once the task DL model 116 has been trained using the loss function DL model 108 generated loss function metric (and optionally one or more additional loss function metrics), the runtime model application component 118 can apply the trained task DL model to unseen data samples 122 to generate the corresponding inference output 124.

In one or more embodiments, the loss function DL model 108 can be trained to predict a FSIM index metric. As noted above, as applied to DL based medical image processing tasks, the FSIM index has been found to provide an assessment of image quality that better correlates with the views of radiologists' perception relative to traditional loss function metrics such as MSE, and SSIM. However, FSIM is non-differentiable and computational sub-components required to compute FSIM such as phase congruency (PC) are non-differentiable and not easily implementable in current DL packages such as TensorFlow. Equation 1 below provides the formulation of FSIM for a given image pair f1(x) and f2(x).

$$FSIM = \frac{\sum {S}_{P C} ( I ) . {S}_{G} ( I ) . P {C}_{m} ( I )}{\sum P {C}_{m} ( I )} \\ Where \\ {S}_{P C} ( I ) = \frac{2 P {C}_{1} ( I ) . P {C}_{2} ( I ) + {T}_{1}}{P {C}_{1}^{2} ( I ) + P {C}_{2}^{2} ( I ) + {T}_{1}} {S}_{G} ( I ) = \frac{2 {G}_{1} ( I ) . {G}_{2} ( I ) + {T}_{2}}{{G}_{1}^{2} ( I ) + {G}_{2}^{2} ( I ) + {T}_{2}} \\ P {C}_{m} ( I ) = max ( P {C}_{1} ( I ) , P {C}_{2} ( I ) ) G = \sqrt{{G}_{x}^{2} + {C}_{y}^{2}} \\ {G}_{x} = [ \begin{matrix}- 0.1875 & 0. & 0.1875 \\ - 0.625 & 0 & 0.625 \\ - 0.1875 & 0. & 0.1875\end{matrix} ] * f ( I ) {G}_{y} = [ \begin{matrix}- 0.1875 & - 0.62 \; 5 & - 0.1875 \\ 0. & 0 & 0. \\ 0.1875 & 0.625 & 0.1875\end{matrix} ] * f ( I ) . \qquad Equation 1$$

In accordance with Equation 1, PC is a phase congruency value corresponding to given image f(x) and ranges between 0 to 1, G is a gradient magnitude along direction x (Gx) and y (Gy) for a given image f(x), and “*” is the convolution operator. The values of T₁ and T₂ are predefined and can vary. In one or more exemplary implementations, T₁ can be set to 0.85 and T₂ can be set to 160.

In one or more embodiments, the loss function DL model 108 can be trained to predict the PC value used to calculate the FSIM. In some implementations of these embodiments, the pluggable loss function component 112 (or another component of the inferencing task module 110) can compute the FSIM index valued used by the task DL model 116 based on the predicted PC value. Alternatively, the loss function DL model 108 can be configured to predict the PC value and compute the FSIM for plugging into the task DL model 116 by the pluggable loss function component 112. In this regard, the phase congruency computation such as log Gabor filter bank is not straightforward to implement using standard DL constructs (e.g., TensorFlow constructs and the like). Thus, in accordance with these embodiments, the disclosed techniques train a DL network (i.e., the loss function DL model 108) to predict the PC value for a given input image.

In accordance with one example implementation, the loss function DL model 108 can be trained to predict the PC value for a variety of different medical images using ground truth PC values for the respective images. According to this example implementation, the training data 102 can include image data from multiple imaging sources, including medical images captured using different modalities, medical images captured of different body parts, etc.

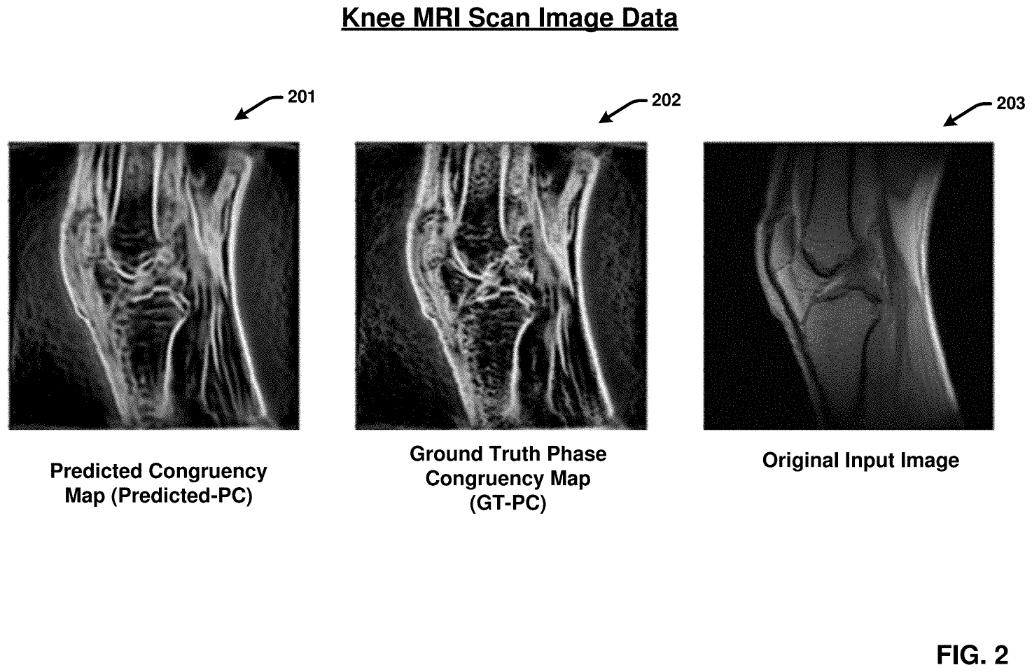

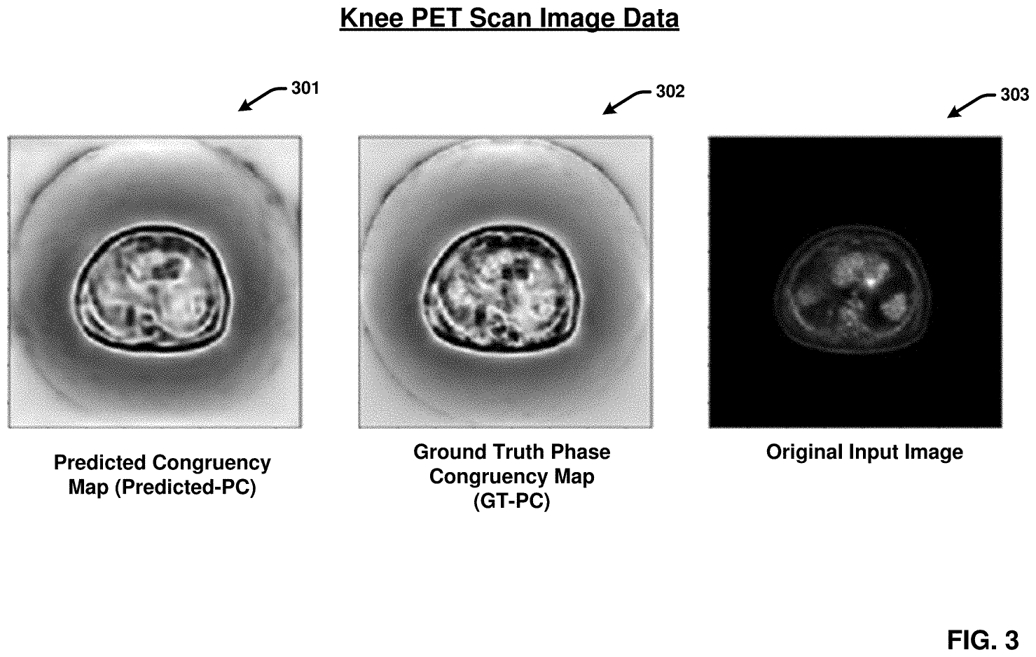

FIGS. 2 and 3 provide results of an example loss function DL model that was trained to predict the PC value (a PC map) for medical images in accordance with the embodiments described herein. In particular, FIG. 2 presents example DL model predicted and ground truth PC maps for a knee MRI scan and FIG. 3 presents example DL model predicted and ground truth PC maps for a knee PET.

In accordance with the examples shown in FIGS. 2 and 3, a 22 layer CNN (a Unet model) was used for the loss function DL model 108, with transpose convolution for upsampling and stride based down sampling, batch normalization turned off and mean absolute error (MAE) as the loss function and executed for 30 epochs. The input data was z-score normalized. The output was the predicted PC map. To generalize the model for various image sizes used in clinical scenario, the model was trained agnostic to the image size, by providing image pairs of various sizes. In particular, the training data 102 used to train the loss function DL model 108 included images from a variety of different medical domains, including about 130,000 brain and knee MRI scans and 5,000 PET thorax and abdomen scans. The training data was split using an 80:20 ratio for training and testing purposes. Mean absolute error between the predicted PC value and the ground truth PC (GT-PC) value was used as the evaluation metric. All the training was done using the functionality provided in Keras toolkit (v2.2.4) and TensorFlow (v.1.13.1) backend.

With reference to FIG. 2, image 203 presents the original input image, a 2D knee MRI scan Image 201 presents the DL model generated PH map (DL-PC) for image 203, and image 202 presents the ground truth PC map for image 203. With reference to FIG. 3, image 303 presents the original input image, a 2D knee PET scan Image 301 presents the DL model generated PH map (DL-PC) for image 303, and image 302 presents the ground truth PC map for image 303. As can be seen by comparison of the GT-PCs with the predicted PCs for both the knee MRI scan and the knee PET scans, both predicted PCs are highly visually similar to their ground truth counterparts, demonstrating that the predicted phase congruency values are sufficiently accurate for image perception applications. These results demonstrate indicate that a DL network can indeed be trained to predict PC value to compute the FSIM loss function, which can be hitherto hard to implement due to tensor construct constraints or where specific implementation details are missing, but final output metric is available.

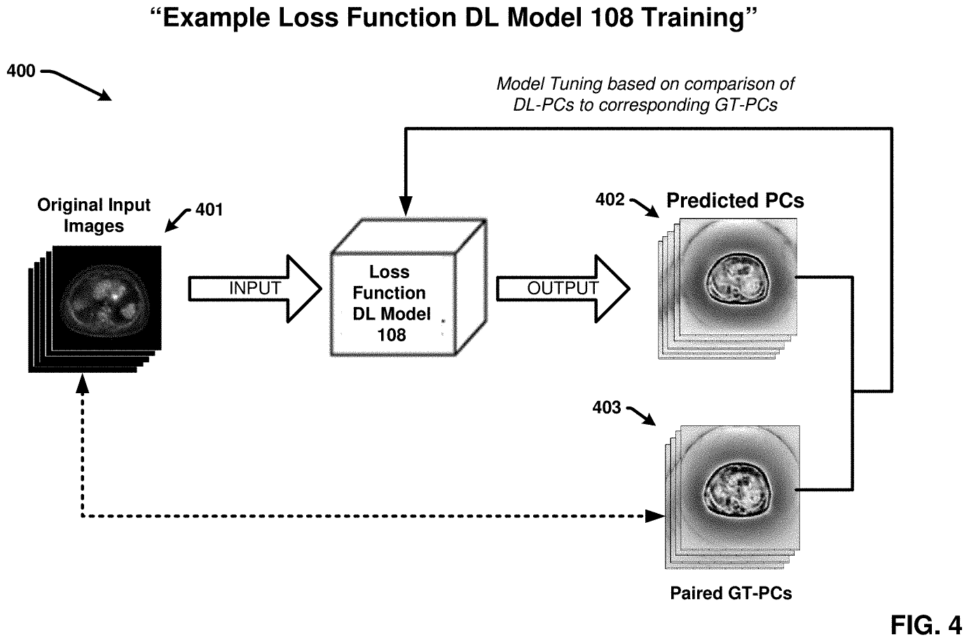

FIG. 4 illustrates an example architecture 400 for training a loss function DL model in accordance with one or more embodiments of the disclosed subject matter. architecture 400 provides a simplified, high-level example of a supervised training process that can be used to generate a loss function DL model to predicts a PC value for a given input image. In accordance with architecture 400, original input images 401 can be input to the loss function DL model 108 (e.g., a CNN or another type of DL network) to generate respective predicted PCs 402. The predicted PCs 402 can then be compared to their paired GT-PCs 403, and the loss function DL model 108 can then be tuned according to account for the differences.

With reference again to FIG. 1, in embodiments in which the loss function DL model 108 is trained to predict the PC value and/or FSIM matrix for a given input image, the loss function DL model 108 can be employed as a pluggable loss function for a variety of different image processing tasks of other DL networks (e.g., the task DL model 116). For example, the loss function DL model 108 can be applied to facilitate performing an image reconstruction task of the task DL model 116, an image-to-image transformation task of the DL model 116 (e.g., denoising, distortion corrections, artifact removal, contrast enhancement, resolution improvement, etc.), an image segmentation task of the task DL model 116, an object recognition task of the task DL model DL 116, and the like.

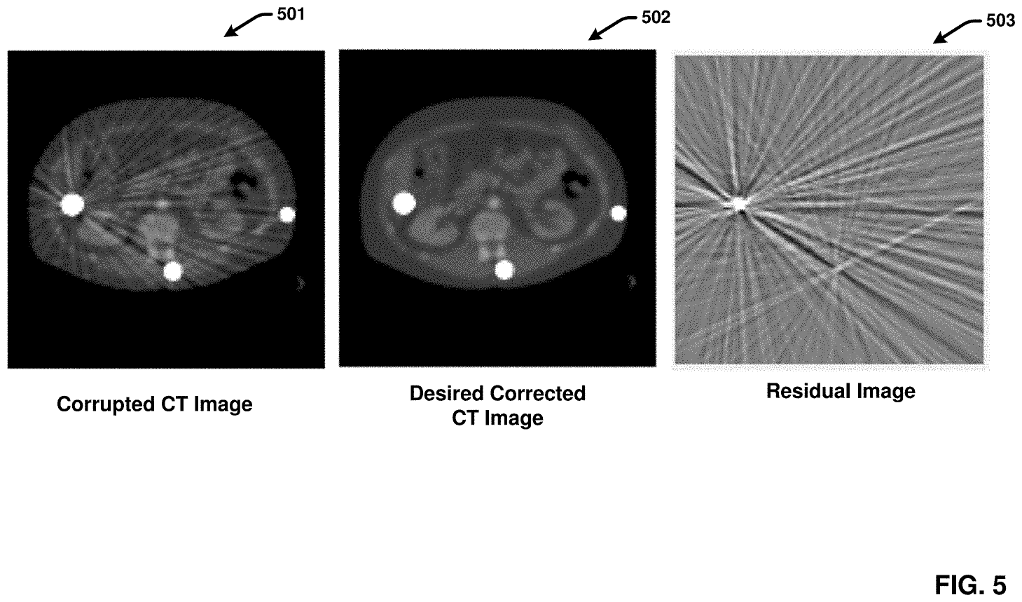

In one example implementation, the example loss function DL model 108 described with reference to FIGS. 2 and 3 was applied as a loss function in training a DL network to perform an image reconstruction problem. In particular, the image reconstruction problem involved removing metal artifacts in medical images; that is reconstructing the medical corrupted medical image to remove the metal artifacts, as exemplified in FIG. 5.

In this regard, FIG. 5 presents example CT image data associated with a DL based image reconstruction task in accordance with one or more embodiments of the disclosed subject matter. Image 501 presents an example corrupted CT image with streaks therein corresponding to metal artifacts. Image 502 presents the desired corrected version of image 501 with the metal artifacts removed, and image 503 presents the residual image comprising the removed portion of the corrupted image 501, which in this example comprises only the metal artifacts.

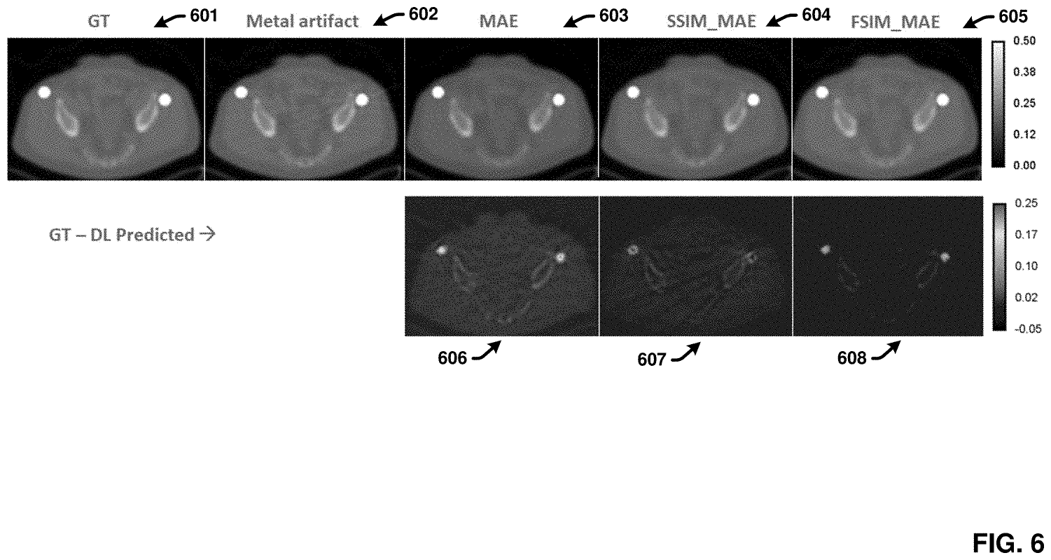

To demonstrate the effectiveness of using a predicted FSIM for the subject image reconstruction problem relative to other loss functions, a metal artifact removal DL network was trained using different loss functions and the same training dataset. These loss functions included MAE alone, MAE in combination with SSIM (SSIM+MAE), and the FSIM loss function (computed using the loss function in DL model 108 described with reference to FIGS. 2 and 3) in combination with MAE. The metal artifact removal DL network was modeled using a standard 2D 3-layer UNet network. The training data set included 1000 corrupted CT images with metal presence in various regions, of which 900 were used for training and 100 were used for testing. The metal artifact removal DL network trained with only the MAE loss function is hereinafter referred to as the MAE network. The metal artifact removal DL network trained with only the both the SSIM and MAE loss functions is hereinafter referred to as the SSIM+MAE network, and the metal artifact removal DL network trained with both the pluggable FSIM loss function and the MAE loss function is hereinafter referred to as the FSIM+MAE network. The results of this experiment are presented with reference to FIGS. 6-9.

FIG. 6 presents image data comparing the different DL based image reconstructions generated using the different loss functions in accordance with the experiment described above Image 601 depicts the ground truth image used for a representative corrupted CT image processed by the metal artifact DL network during the testing phase. Image 602 presents the corresponding corrupted image. Image 603 depicts the resulting image generated by the MAE network, image 604 depicts the resulting image generated by the SSIM+MAE network, and image 605 depicts the resulting image generated by the FSIM+MAE network.

Images 606-608 are the subtraction images of the model output images (images 603-605) from the ground truth image 601. In particular, image 606 is the subtraction image resulting from subtraction of image 603 from image 601, image 607 is the subtraction image resulting from subtraction of image 604 from image 601, and image 608 is the subtraction image resulting from subtraction of image 605 from image 601. The intensity of the tissue appearing in a subtraction images directly correlates to the degree of similarity between the ground truth image and the network generated images, wherein the lower the intensity, the higher the similarity. As can be seen by comparison of all three subtraction images, the subtraction image 608 for the FSIM+MAE network generated image 605 clearly has the least amount of residual tissue. This demonstrates that FSIM+MAE networks better in retaining tissue structure when removing metal artifacts compared to MAE only and SSIM+MAE networks.

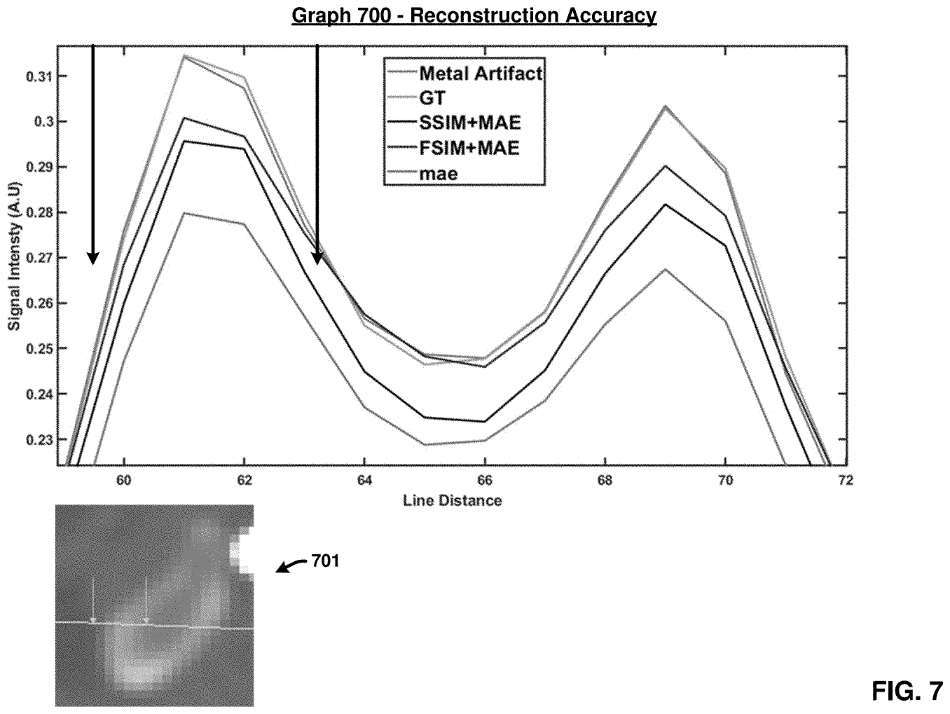

FIG. 7 presents a graph 700 comparing the reconstruction accuracy of different DL based image reconstruction networks in accordance with the experiment described above. With reference to FIG. 7 and FIG. 6, to generate graph 700, the signal intensity of the respective images 601-605 was measured across a same bone structure appearing in the images. For example, image 701 presents a zoomed in view of a portion of one of the images 601-605, wherein the lighter part of the image corresponds to the bone structure evaluated. The two arrows are marked in image 701 correspond to the arrows marked in graph 700 and indicate the corresponding portion of the bone over which the signal intensity is measured. In accordance with graph 700 in view of image 701, the signal intensity should increase or peak where the bone structure starts and decrease where the bon structure stops. Graph 700 demonstrates that the FSIM+MAE network generated image has greater signal intensity and fidelity over the corresponding measured portions of the images generated using the SSIM+MAE network and the MAE network.

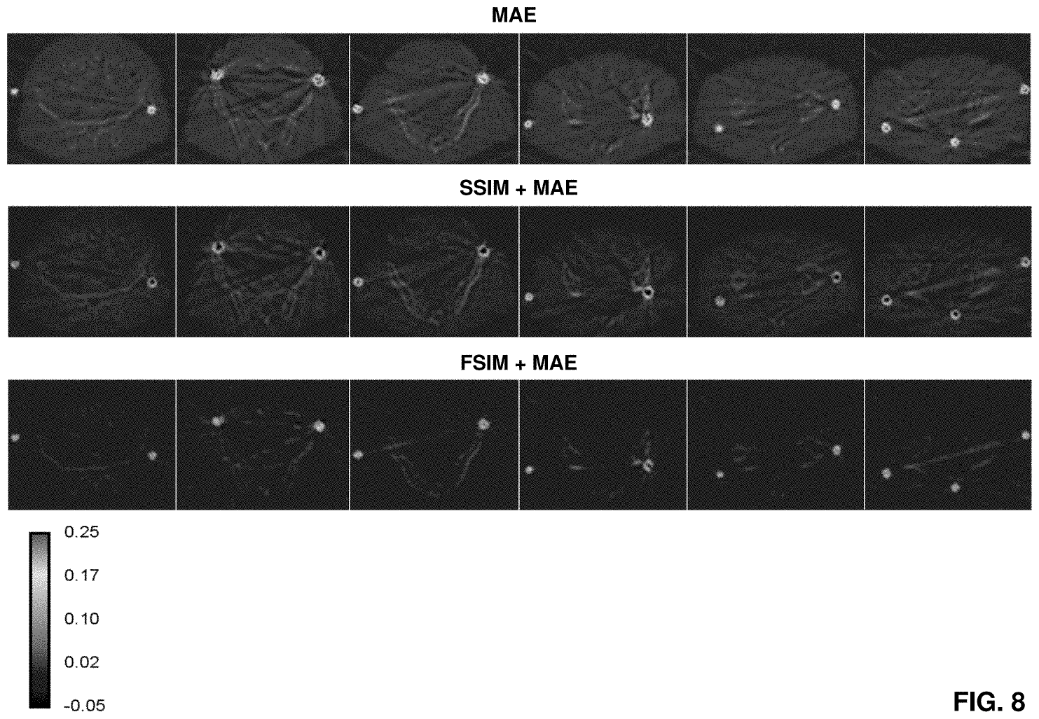

FIG. 8 presents additional image data comparing different DL based image reconstructions generated using the different loss functions in accordance with the experiment described above. In particular, FIG. 8 presents several subtraction images for the different loss function trained networks. The subtraction images were generated by subtracting the network generated image from its corresponding ground truth image. Each subtraction image stacked above one another in each column was generated using the same input image and evaluated using the same ground truth image. As can be seen by comparison of the subtraction images for the FSIM+MAE network to the other two networks, the subtraction images for the FSIM+MAE network collectively and consistently have less residual tissue intensity. This demonstrates that the metal artifact correction images generated using the FSIM+MAE trained network more closely match their corresponding ground truth images in appearance relative to the image generated using the other two networks. This indicates that the FSIM+MAE trained network has learned the background tissue of the CT image structures better than the other two networks.

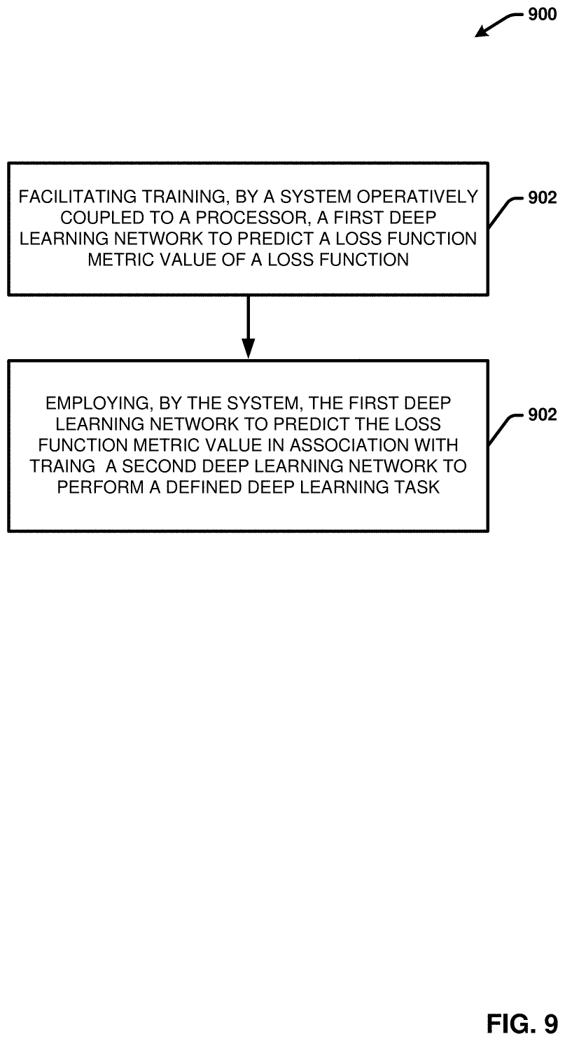

FIG. 9 illustrates a flow diagram of an example, non-limiting process 900 for learning a loss functions using a first DL network and employing the loss functions to train a second DL network in accordance with one or more embodiments of the disclosed subject matter. Repetitive description of like elements employed in respective embodiments is omitted for sake of brevity.

At 902, a system operatively coupled to a processor (e.g., system 100) can facilitating training (e.g., using loss function training component 106) a first deep learning network (e.g., loss function DL model 108) to predict a loss function metric value (e.g., the PC value) of a loss function (e.g., an FSIM based loss function). At 904, the system can employ the first deep learning network to predict the loss function metric value in association with training a second deep learning network (e.g., task DL model 116) to perform a defined deep learning task.

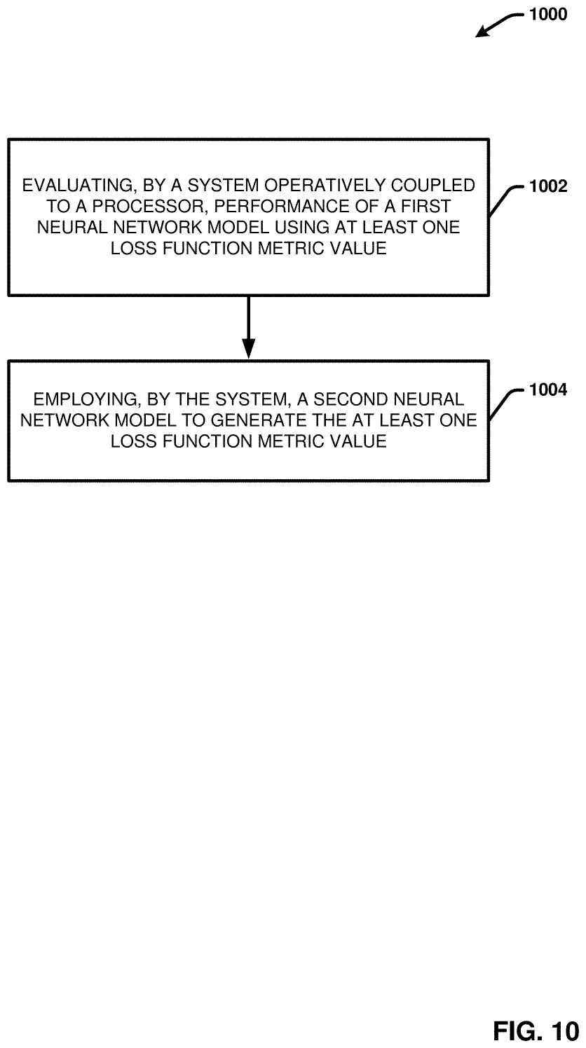

FIG. 10 illustrates a flow diagram of another example, non-limiting process 100 for learning a loss functions using a first DL network and employing the loss functions to train a second DL network in accordance with one or more embodiments of the disclosed subject matter.

At 1002, a system operatively coupled to a processor (e.g., system 100) can evaluate performance (e.g., using task model training component 114) of a first neural network model (e.g., task DL model 116) using at least one loss function metric value (e.g., an FSIM index value). At 1004, the system can employ (e.g., using pluggable loss function component 112) a second neural network model (e.g., loss function DL model 108) to generate the at least one loss function metric value (e.g., an FSIM metric value).

It should be noted that, for simplicity of explanation, in some circumstances the computer-implemented methodologies are depicted and described herein as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

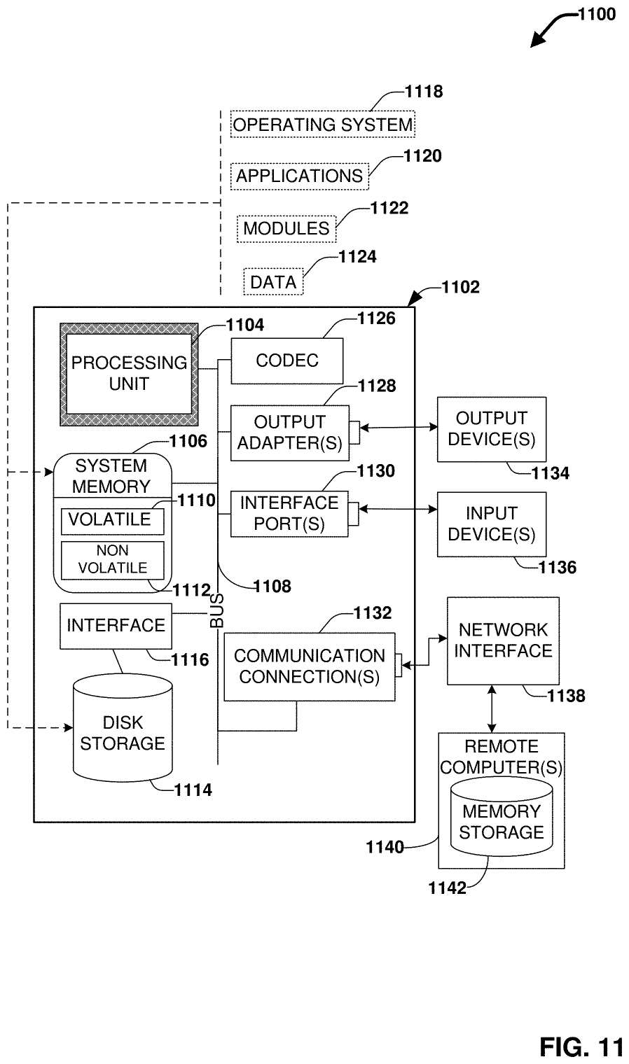

FIG. 11 can provide a non-limiting context for the various aspects of the disclosed subject matter, intended to provide a general description of a suitable environment in which the various aspects of the disclosed subject matter can be implemented. FIG. 11 illustrates a block diagram of an example, non-limiting operating environment in which one or more embodiments described herein can be facilitated. Repetitive description of like elements employed in other embodiments described herein is omitted for sake of brevity.

With reference to FIG. 11, a suitable operating environment 1100 for implementing various aspects of this disclosure can also include a computer 1102. The computer 1102 can also include a processing unit 1104, a system memory 1106, and a system bus 1108. The system bus 1108 couples system components including, but not limited to, the system memory 1106 to the processing unit 1104. The processing unit 1104 can be any of various available processors. Dual microprocessors and other multiprocessor architectures also can be employed as the processing unit 1104. The system bus 1108 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 11124), and Small Computer Systems Interface (SCSI).

The system memory 1106 can also include volatile memory 1110 and nonvolatile memory 1112. The basic input/output system (BIOS), containing the basic routines to transfer information between elements within the computer 1102, such as during start-up, is stored in nonvolatile memory 1112. Computer 1102 can also include removable/non-removable, volatile/non-volatile computer storage media. FIG. 11 illustrates, for example, a disk storage 1114. Disk storage 1114 can also include, but is not limited to, devices like a magnetic disk drive, floppy disk drive, tape drive, Jaz drive, Zip drive, LS-100 drive, flash memory card, or memory stick. The disk storage 1114 also can include storage media separately or in combination with other storage media. To facilitate connection of the disk storage 1114 to the system bus 1108, a removable or non-removable interface is typically used, such as interface 1116. FIG. 11 also depicts software that acts as an intermediary between users and the basic computer resources described in the suitable operating environment 1100. Such software can also include, for example, an operating system 1118. Operating system 1118, which can be stored on disk storage 1114, acts to control and allocate resources of the computer 1102.

System applications 1120 take advantage of the management of resources by operating system 1118 through program modules 1122 and program data 1124, e.g., stored either in system memory 1106 or on disk storage 1114. It is to be appreciated that this disclosure can be implemented with various operating systems or combinations of operating systems. A user enters commands or information into the computer 1102 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1104 through the system bus 1108 via interface port(s) 1130. Interface port(s) 1130 include, for example, a serial port, a parallel port, a game port, and a universal serial bus (USB). Output device(s) 1134 use some of the same type of ports as input device(s) 1136. Thus, for example, a USB port can be used to provide input to computer 1102, and to output information from computer 1102 to an output device 1134. Output adapter 1128 is provided to illustrate that there are some output devices 1134 like monitors, speakers, and printers, among other output devices 1134, which require special adapters. The output adapters 1128 include, by way of illustration and not limitation, video and sound cards that provide a means of connection between the output device 1134 and the system bus 1108. It should be noted that other devices and/or systems of devices provide both input and output capabilities such as remote computer(s) 1140.

Computer 1102 can operate in a networked environment using logical connections to one or more remote computers, such as remote computer(s) 114. The remote computer(s) 1140 can be a computer, a server, a router, a network PC, a workstation, a microprocessor based appliance, a peer device or other common network node and the like, and typically can also include many or all of the elements described relative to computer 1102. For purposes of brevity, only a memory storage device 1142 is illustrated with remote computer(s) 1140. Remote computer(s) 1140 is logically connected to computer 1102 through a network interface 1138 and then physically connected via communication connection 1132. Network interface 1138 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1132 refers to the hardware/software employed to connect the network interface 1138 to the system bus 1108. While communication connection 1132 is shown for illustrative clarity inside computer 1102, it can also be external to computer 1102. The hardware/software for connection to the network interface 1138 can also include, for exemplary purposes only, internal and external technologies such as, modems including regular telephone grade modems, cable modems and DSL modems, ISDN adapters, and Ethernet cards.

One or more embodiments described herein can be a system, a method, an apparatus and/or a computer program product at any possible technical detail level of integration. The computer program product can include a computer readable storage medium (or media) having computer readable program instructions thereon for causing a processor to carry out aspects of one or more embodiment. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. In this regard, in various embodiments, a computer readable storage medium as used herein can include non-transitory and tangible computer readable storage mediums.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of one or more embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of one or more embodiments.

Aspects of one or more embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and other devices to function in a particular manner, such that the computer readable storage medium having instructions stored therein comprises an article of manufacture including instructions which implement aspects of the function/act specified in the flowchart and block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and block diagram block or blocks.

The flowchart and block diagrams in the Figures illustrate the architecture, functionality, and operation of possible implementations of systems, methods, and computer program products according to various embodiments described herein. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and flowchart illustration, and combinations of blocks in the block diagrams and flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on one or more computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices. For example, in one or more embodiments, computer executable components can be executed from memory that can include or be comprised of one or more distributed memory units. As used herein, the term “memory” and “memory unit” are interchangeable. Further, one or more embodiments described herein can execute code of the computer executable components in a distributed manner, e.g., multiple processors combining or working cooperatively to execute code from one or more distributed memory units. As used herein, the term “memory” can encompass a single memory or memory unit at one location or multiple memories or memory units at one or more locations.

As used in this application, the terms “component,” “system,” “platform,” “interface,” and the like, can refer to and can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and a computer. By way of illustration, both an application running on a server and the server can be a component. One or more components can reside within a process or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that can provide specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result (e.g., including employing ML and/or AI techniques to determine the intermediate results), etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to: sensors, antennae, audio and/or visual output devices, other devices, etc.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches, and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components; and
a processor that executes the computer executable components stored in the memory, wherein the computer executable components comprise:
a loss function training component that facilitates training a first deep learning network to predict a loss function metric value of a loss function; and
a pluggable loss function component that facilitates applying the first deep learning network to predict the loss function metric value in association with training a second deep learning network to perform a defined deep learning task.

2. The system of claim 1, wherein the loss function comprises a non-differentiable loss function.

3. The system of claim 1, wherein the loss function comprises a feature similarity index match (FSIM) loss function.

4. The system of claim 3, wherein the loss function metric value comprises a feature similarity index metric value.

5. The system of claim 3, wherein the loss function metric value comprises a phase congruency metric value.

6. The system of claim 1, wherein the loss function comprises a system transfer function.

7. The system of claim 1, wherein the loss function comprises a visual information fidelity (VIF) loss function.

8. The system of claim 1, wherein the second deep learning network requires a defined software framework for execution and wherein the defined software framework cannot execute the loss function.

9. The system of claim 8, wherein the defined software framework employs a tensor construct and wherein the tensor construct cannot calculate the loss function.

10. The system of claim 1, wherein the defined deep learning task comprises an image reconstruction task or an image transformation task.

11. The system of claim 1, wherein the first deep learning network comprises a convolutional neural network.

12. A method, comprising:
evaluating, by a system operatively coupled to a processor, performance of a first neural network model using at least one loss function metric value; and
employing, by the system, a second neural network model to generate the at least one loss function metric value.

13. The method of claim 12, wherein the loss function metric value comprises a non-differentiable loss function metric value.

14. The method of claim 12, wherein the loss function metric value comprises a feature similarity index match (FSIM) metric value.

15. The method of claim 13, wherein the second neural network is configured to predict a phase congruency metric value and employ the phase congruency metric value to generate the similarity index match (FSIM) metric value.

16. The method of claim 12, wherein the loss function metric value comprises a system transfer function metric value.

17. The method of claim 12, wherein the first neural network model comprises an image reconstruction model or an image transformation model.

18. The method of claim 12, wherein the second deep learning network comprises a convolutional neural network that was trained to predict the loss function metric value using supervised or semi-supervised machine learning training.

19. A method comprising:
facilitating training, by a system operatively coupled to a processor, a first deep learning network to predict a loss function metric value of a loss function; and
employing, by the system, the first deep learning network to predict the loss function metric value in association with training a second deep learning network to perform a defined deep learning task.

20. The method of claim 19, wherein the loss function comprises a non-differentiable loss function.
